(19) United States
(12) Patent Application Publication
(10) Pub. No.: US 2015/0052001 A1
(43) Pub. Date: Feb. 19, 2015

(54) USER-SPECIFIC SEAT RECOMMENDATIONS BASED ON COMMON INTERESTS

(71) Applicant: Mark Delun Yuan, San Jose, CA (US)

(72) Inventor: Mark Delun Yuan, San Jose, CA (US)

(21) Appl. No.: 13/966,649

(22) Filed: Aug. 14, 2013

(51) Int. Cl. G06Q 30/06; G06Q 10/02

(52) U.S. Cl. CPC G06Q 30/0631; G06Q 10/02
USPC 705/26.7

(57) ABSTRACT

Computing systems and methods for purchasing tickets and attending ticketed events are disclosed. A computing system includes one or more memory device or storage components adapted to store user information regarding users of the computing system as well as event information regarding upcoming ticketed events, and one or more processors for conducting activities regarding ticketing. Such activities can include displaying information regarding a ticketed event, accepting a user input regarding search terms or preferences for the ticketed event, comparing the user input to known information regarding past ticket purchases for that ticketed event, and recommending specific tickets to the user based upon the comparison.

### TECHNICAL FIELD

The present disclosure relates generally to electronic commerce, and more particularly to electronic systems and methods for assisting users in activities relating to purchases and attendance at ticketed events, such as sitting with fellow fans.

### BACKGROUND

Computer systems and networks have facilitated the tasks of buying, selling and transferring goods. For example, global computer networks, such as the Internet, have allowed purchasers to relatively quickly and efficiently seek and purchase goods online. Similarly, global computer networks provide an efficient and cost-effective medium for sellers to advertise, offer, provide and sell their goods. Electronic commerce companies provide buyers and sellers with online services and the infrastructure to accept orders of goods from remote purchasers, to perform the financial transactions necessary to confirm and complete the sale of goods, to ship or distribute the goods to remote purchasers and to perform other related logistics.

One example of a market for goods within the realm of electronic commerce is the online ticket. Many different websites and parties buy, sell and provide marketplaces for tickets online, and the ability for individuals to buy and sell tickets online is now generally well known. These tickets can be for a variety of live events, such as, for example, sports, concerts, theater and other entertainment events.

Unfortunately, the process for a person desiring to attend a ticketed event can often be cumbersome and uncertain. For example, many fans and other ticket buyers are often not sure of the area where they might be sitting, and whether there would be friendly or hostile fans nearby. Such concerns can sometimes be increased where a single person might be considering attending a ticketed event alone. The uncertainty over such issues can often discourage some from attending altogether.

Although many systems and methods for purchasing tickets and attending ticketed events have generally worked well in the past, there is always a desire for improvement. In particular, it can be desirable to provide systems and methods that assist users in purchasing tickets for ticketed events in a manner that results in a higher likelihood that users will be seated at or near people of similar likes, interests and/or team allegiances.

### BRIEF DESCRIPTION OF THE DRAWINGS

The included drawings are for illustrative purposes and serve only to provide examples of possible systems and methods for the disclosed purchases of tickets for ticketed events. These drawings in no way limit any changes in form and detail that may be made to that which is disclosed by one skilled in the art without departing from the spirit and scope of this disclosure.

FIG. 1 illustrates in block diagram format an exemplary computing system adapted for implementing one or more processes involving activities with respect to purchasing and attendance at ticketed events, such as sitting with fellow fans, according to one embodiment of the present invention.

FIG. 2 illustrates in block diagram format an exemplary computer system suitable for implementing on one or more devices of the computing system in FIG. 1, according to one embodiment of the present invention.

FIG. 3 illustrates a screenshot of an exemplary service provider interest page offering tickets to a ticketed event of interest, wherein a user can elect to sit with one or more fellow fans, according to one embodiment of the present invention.

FIG. 4 provides a flowchart of an exemplary method of facilitating the purchase of tickets to sit with fellow fans for a ticketed event, according to one embodiment of the present invention.

### DETAILED DESCRIPTION

Various embodiments of systems and methods for facilitating the purchase of tickets that seat the user with fellow fans are disclosed herein. Such systems and methods can facilitate various activities related to purchases and attendance, such as at ticketed events.

Exemplary applications of apparatuses and methods according to the present invention are described in this section. These examples are being provided solely to add context and aid in the understanding of the invention. It will thus be apparent to one skilled in the art that the present invention may be practiced without some or all of these specific details. In other instances, well known process steps have not been described in detail in order to avoid unnecessarily obscuring the present invention. Other applications are possible, such that the following examples should not be taken as limiting.

In the following detailed description, references are made to the accompanying drawings, which form a part of the description and in which are shown, by way of illustration, specific embodiments of the present invention. Although these embodiments are described in sufficient detail to enable one skilled in the art to practice the invention, it is understood that these examples are not limiting, such that other embodiments may be used, and changes may be made without departing from the spirit and scope of the invention.

The present invention relates in various embodiments to devices, systems and methods involving activities with respect to ticketed events. In various particular embodiments, the subject ticket offering and purchasing devices, systems or methods can involve one or more user devices in communication over a network. Such a network can facilitate a streamlined process involving the discovery, inviting, discussion and purchase of tickets for similar minded or aligned event attendees.

While the various examples disclosed herein focus on particular aspects regarding ticketed events, it will be understood that the various inventive principles and embodiments disclosed herein can be applied to other types of ticketed applications and arrangements as well. For example, an event to be attended by only one or two people may utilize one or more of the various aspects and features found in the various systems and methods provided.

For example, when a user searches online for tickets, such as by using StubHub, the user can be provided with a list of available tickets based on factors such as price, section, and available quantity, without regard for the type of fan that the user is or who the user is cheering for. According to an embodiment, the system can look at the search query submitted by the user to determine whether the user is a fan of the home team or the away team.

For example, for a 49ers-Raiders game, if one user is a 49ers fan, then that user will likely search for “49ers tickets” while another user who is a Raiders fan will likely search for “Raiders tickets” even though both users are searching for tickets to the same game. According to an embodiment, the system can recognize that a user got to a game page by searching for a team name and then the system can return or highlight tickets to the game for sections or areas of the stadium where similar fans are sitting (such as determined by purchase activity of other users, for example). Thus, a user can easily purchase tickets that allow the user to sit with fellow fans. Similarly, the user can easily purchase tickets that allow the user to sit with others having similar interest, such as type of beverages enjoyed (soft drinks vs. alcohol, for example), type of food enjoyed, (hot dogs vs. steaks, for example), and/or the view desired (infield vs. outfield, for example).

The criteria for sitting the user next to others can be related to the event (such as requiring that the user and the others be fans of the same team), or can be unrelated to the event. For example, the criteria can be that the user and the others be members of the same church, club or other organization. As a further example, the criteria can require that the user and the other be employees of the same company. The criteria can relate to physical attributes of the user and the others. For example, the criteria can be age related or sex related. Thus, adults can chose to sit with other adults, for example.

Criteria can be combined in any desired manner. In this manner, adult men that belong to the same church and that are all fans of the same team can sit together, for example.

Information for use by the system to determine which individuals at a ticketed event fulfill such criteria can be obtained from the individuals, from social networking sites, from databases, from payment providers, from merchants, or from anywhere else. Information can be obtained from individuals, for example, by having system participants fill out a questionnaire. Information obtained from payment providers and/or merchants can include purchase histories. Purchase histories can be indicative of likes or desires of such individuals.

According to an embodiment, the system can take into account the type of fan of the user. For example, the user can be a casual fan or a hardcore fan. This can be accomplished either by determining through user-entered preferences or through user activity, such as user purchase activity (a casual fan may buy a few tickets a year, while a hardcore fan may buy more tickets a year). This way, for a casual Giants fan who just wants to attend a game to drink wine and socialize, the system can offer the casual fan tickets in sections close to the wine or beer stands and/or near other casual fans. Conversely, the system can offer the hardcore fan tickets in the bleachers or other areas where hardcore fans typically sit.

Other data could be examined to determine the type of fan a user is, such as whether the user is a local fan or an out-of-town fan (via IP address of the user, GPS, etc.), average price of ticket that the user is looking at or has purchased in the past, demographic information, etc. Determination of the character/makeup of a section in a stadium can be inferred from information about the users who have purchased tickets in that section (e.g., demographic information, price of the ticket, proximity to different food and alcohol stands, etc.).

According to an embodiment, a computing system can comprise one or more memory device or storage components adapted to store user information. For example, the user information can be information regarding one or more users of the computing system. The one or more memory device or storage components can be further adapted to store event information. The event information can be information regarding a plurality of upcoming ticketed events.

According to an embodiment, one or more hardware processors can be in communication with the one or more memory device or storage components. The one or more hardware processors can be adapted to facilitate displaying information, such as information regarding a ticketed event. The one or more hardware processors can be adapted to accept an input, such as an input from a user regarding the ticketed event. The one or more hardware processors can be adapted to evaluate the input, such as with respect to known information. The known information can be information regarding previous ticket purchases. The one or more hardware processors can be adapted to make a ticket or seating recommendation to the user, such as a recommendation based, at least in part, upon the input and evaluation.

The known information can be evaluated, for example, to determine a team to which the user has allegiance, e.g., is a fan. The ticket or seating recommendation can be for a seat with other fans of the same team. The ticket or seating recommendation can be for a seat with others who share interests, desires, attributes, or other factors with the user.

The user can be determined to be a fan of a team for which the user has performed an online search for the team name. For example, the user can be determined to be a fan of a team for which the user has performed an online search for tickets using the team name or other information that identifies or implies an identification of the team.

The other fans of the same team can be determined in a similar fashion. Thus, the other fans of the same team can be determined, at least in part, by online search terms used by the other fans.

Team allegiances can be inferred from activities of the user and others, such as from online activities of the user and others. A team allegiance can indicate that a person is a fan or is likely to be a fan of the team. Any information from any source that is available to the system can be used to infer team allegiances. Thus, purchasing tickets, souvenirs, memorabilia, toys, novelties, or other products that relate to a team or that can be used to infer a relationship to the team can be used by the system to infer the team allegiance.

The activities, e.g., purchase history, of one person can be used to infer the team allegiance of another person. For example, members of a family can be determined to have similar team allegiances. Thus, the activities of one member of a family can determine the team allegiances for other members of the family. As a further example, neighbors can be determined to have similar team allegiances.

As a further example, members of the same organization, such as member of a church, club, or people employed by the same company, can be determined to have similar team allegiances. Thus, the activities of one member of an organization can determine the team allegiances for other members of the organization.

Location can be used by the system to infer the team allegiance. For example, people located in the home city of a team can be determined to have allegiance to that team. Time can be used by the system to infer the team allegiance. For example, people who repeatedly purchase tickets or related products when a visiting team is in town can be determined to have allegiance to the visiting team.

Travel can be used by the system to infer the team allegiance. For example, people who tend to travel to the same cities that a team travels to can be determined to have allegiance to the team. The travel history of a person can be obtained from the person's travel ticket, e.g., airline ticket, purchase history, from other purchase histories (such as from the locations where purchases were made by the person), or from any other information.

The user can know one or more of the other fans with which the user is seated. Alternatively, the user can not know any of the other fans with which the user is seated. The user can specify, such as in a set up process, whether the user wants to sit with fans that the user does not know. The user can specify, such as during the set up process, priorities for attributes of the fans with which the user sits.

For example, the user can give priority to fans that the user knows (such as by listing such fans). In this instance, the system can first attempt to sit the user with fans that the user know and can only sit the user with fans that the user does not know when no fans are available that the user knows.

The system can track who the user sits with from event to event. Thus, if the user must sit with others that the user does not know, then the system may be able to at least sit the user with others that the user has sat with before.

The event information can include information regarding the identity of a first event, when and where the first event is happening, and what tickets, sections and pricing are available for the first event. The event information can include any other information regarding the event, other events (such as other events at the same venue or within a similar time frame).

The one or more hardware processors can be further adapted to facilitate providing the response information to the user. The response can be communicated to the user in the same fashion that the user provided an input to the one or more hardware processors, such as via a cellular or data network, e.g., the Internet.

The ticket or seating recommendation can be based, at least in part, on personal information about the user. For example, the ticket or seating recommendation can be suggested based, at least in part, on at least one of a browsing history, a purchase history, social information, location, or interest of the user. The ticket or seating recommendation can be suggested based, at least in part, on entered search terms.

Thus, a user interested in purchasing a ticket to an event can be provided with recommendations or suggestions as to where others of similar interests or similar criteria for enjoyment have purchased tickets. This way, the user can determine a seat location that may increase the enjoyment of the event for the user. The similar interests and/or criteria may be determined through pre-set preferences and/or analysis of information from social networks, purchase histories, search histories, and other available information.

### Systems and Devices

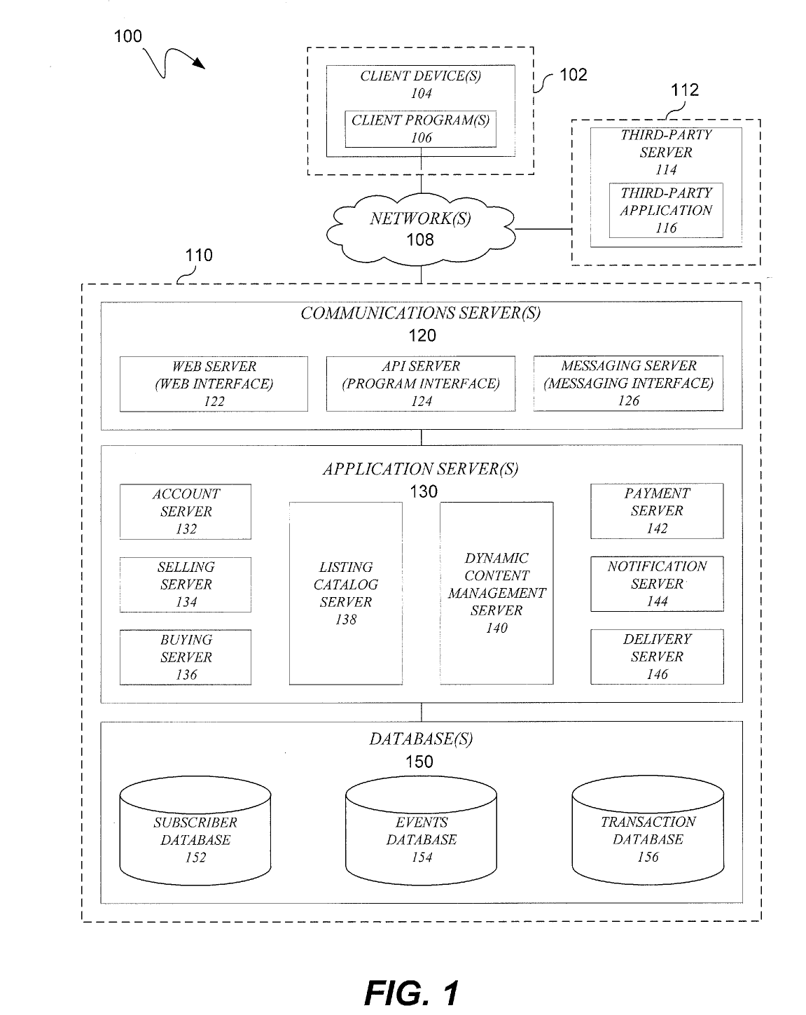

Beginning with FIG. 1, an exemplary embodiment of a computing system adapted for implementing one or more processes involving the organization of fan attended ticketed events is illustrated in block diagram format. As shown, computing system 100 may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

Computing system 100 can include, among various devices, servers, databases and other elements, a client 102 that may comprise or employ one or more client devices 104, such as a mobile computing device, a PC and/or any other computing device having computing and/or communications capabilities in accordance with the described embodiments. Client devices 104 generally may provide one or more client programs 106, such as system programs and application programs to perform various computing and/or communications operations. Exemplary system programs may include, without limitation, an operating system (e.g., MICROSOFT® OS, UNIX® OS, LINUX® OS, Symbian OS™, Embedix OS, Binary Run-time Environment for Wireless (BREW) OS, JavaOS, a Wireless Application Protocol (WAP) OS and others), device drivers, programming tools, utility programs, software libraries, application programming interfaces (APIs) and so forth. Exemplary application programs may include, without limitation, a web browser application, messaging applications (e.g., e-mail, IM, SMS, MMS, telephone, voicemail, VoIP, video messaging), contacts application, calendar application, electronic document application, database application, media application (e.g., music, video, television), location-based services (LBS) application (e.g., GPS, mapping, directions, point-of-interest, locator) and so forth. One or more of client programs 106 may display various graphical user interfaces (GUIs) to present information to and/or receive information from one or more of client devices 104.

As shown, client 102 can be communicatively coupled via one or more networks 108 to a network-based system 110. Network-based system 110 may be structured, arranged, and/or configured to allow client 102 to establish one or more communications sessions with network-based system 110 using various computing devices 104 and/or client programs 106. Accordingly, a communications session between client 102 and network-based system 110 may involve the unidirectional and/or bidirectional exchange of information and may occur over one or more types of networks 108 depending on the mode of communication. While the embodiment of FIG. 1 illustrates a computing system 100 deployed in a client-server operating environment, it is to be understood that other suitable operating environments and/or architectures may be used in accordance with the described embodiments.

Data and/or voice communications between client 102 and the network-based system 110 may be sent and received over one or more networks 108 such as the Internet, a WAN, a WWAN, a WLAN, a mobile telephone network, a landline telephone network, a VoIP network, as well as other suitable networks. For example, client 102 may communicate with network-based system 110 over the Internet or other suitable WAN by sending and or receiving information via interaction with a web site, e-mail, IM session and/or video messaging session. Any of a wide variety of suitable communication types between client 102 and system 110 can take place, as will be readily appreciated.

In various embodiments, computing system 100 can include, among other elements, a third party 112, which may comprise or employ a third-party server 114 hosting a third-party application 116. In various implementations, third-party server 314 and/or third-party application 116 may host a web site associated with or employed by a third party 112. For example, third-party server 114 and/or third-party application 116 may enable network-based system 110 to provide client 102 with additional services and/or information, such as additional ticket inventory. In some embodiments, one or more of client programs 106 may be used to access network-based system 110 via third party 112. For example, client 102 may use a web client to access and/or receive content from network-based system 110 after initially communicating with a third-party web site 112.

Network-based system 110 may comprise one or more communications servers 120 to provide suitable interfaces that enable communication using various modes of communication and/or via one or more networks 108. Communications servers 120 can include a web server 122, an API server 124 and/or a messaging server 126 to provide interfaces to one or more application servers 130. Application servers 130 of network-based system 110 may be structured, arranged and/or configured to provide various online marketplace and/or ticket fulfillment services to users that access network-based system 110. In various embodiments, client 102 may communicate with applications servers 130 of network-based system 110 via one or more of a web interface provided by web server 122, a programmatic interface provided by API server 124 and/or a messaging interface provided by messaging server 126. It can be appreciated that web server 122, API server 124 and messaging server 126 may be structured, arranged and/or configured to communicate with various types of client devices 104 and/or client programs 106 and may interoperate with each other in some implementations.

Web server 122 may be arranged to communicate with web clients and/or applications such as a web browser, web browser toolbar, desktop widget, mobile widget, web-based application, web-based interpreter, virtual machine, and so forth. API server 124 may be arranged to communicate with various client programs 106 and/or a third-party application 116 comprising an implementation of API for network-based system 110. Messaging server 126 may be arranged to communicate with various messaging clients and/or applications such as e-mail, IM, SMS, MMS, telephone, VoIP, video messaging, and so forth, and messaging server 126 may provide a messaging interface to enable access by client 102 and/or third party 112 to the various services and functions provided by application servers 130.

When implemented as an online ticket marketplace, application servers 130 of network-based system 110 may provide various online marketplace and ticket fulfillment services including, for example, account services, buying services, selling services, listing catalog services, dynamic content management services, delivery services, payment services, and notification services. Application servers 130 may include an account server 132, a buying server 134, a selling server 136, a listing catalog server 138, a dynamic content management server 140, a payment server 142, a notification server 144, and/or a delivery server 146 structured and arranged to provide such online marketplace and ticket fulfillment services.

Application servers 130, in turn, may be coupled to and capable of accessing one or more databases 150 including a subscriber database 152, an active events database 154, and/or a transaction database 156. Databases 150 generally may store and maintain various types of information for use by application servers 130 and may comprise or be implemented by various types of computer storage devices (e.g., servers, memory) and/or database structures (e.g., relational, object-oriented, hierarchical, dimensional, network) in accordance with the described embodiments. Further details regarding the various components, capabilities and features of computing system 100 can be found at, for example, U.S. patent application Ser. No. 13/293,854, entitled “Intelligent Seat Recommendation,” filed on Nov. 10, 2011, which is incorporated herein by reference in its entirety.

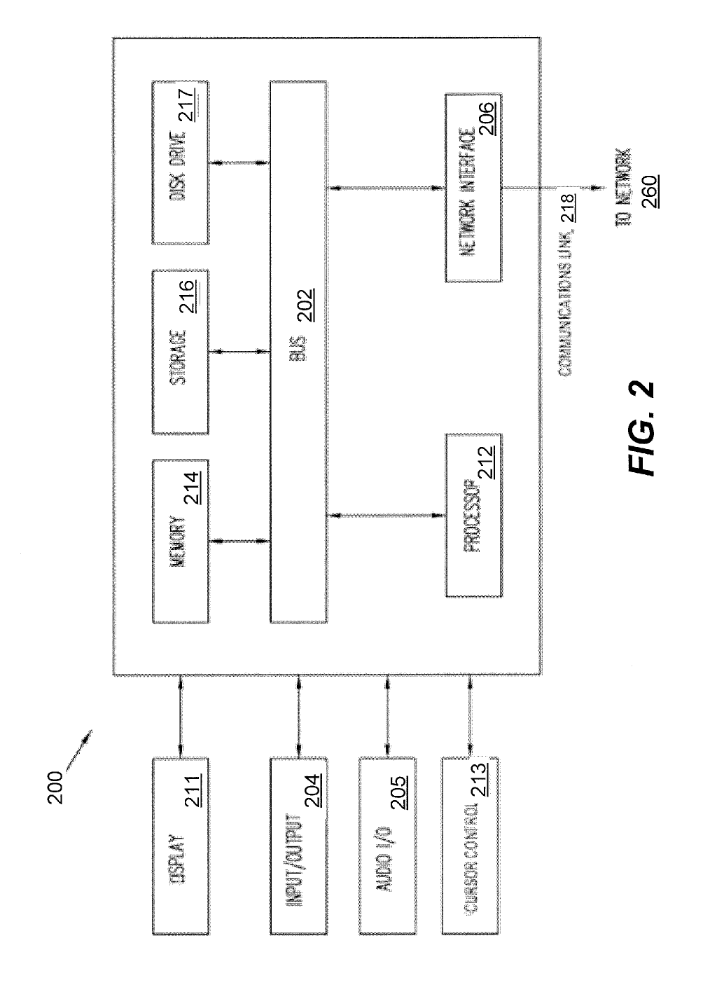

Continuing with FIG. 2, an exemplary computer system 200 suitable for implementing on one or more devices of the computing system in FIG. 1 is depicted in block diagram format. In various implementations, a device that includes computer system 200 may comprise a personal computing device (e.g., a smart phone, a computing tablet, a personal computer, laptop, PDA, Bluetooth device, key FOB, badge, etc.) that is capable of communicating with a network. The ticket provider and/or a payment provider may utilize a network computing device (e.g., a network server) capable of communicating with the network. It should be appreciated that each of the devices utilized by users, ticket providers, and payment providers may be implemented as computer system 200 in a manner as follows.

Computer system 200 can include a bus 202 or other communication mechanism for communicating information data, signals, and information between various components of computer system 200. Components include an input/output (I/O) component 204 that processes a user action, such as selecting keys from a keypad/keyboard, selecting one or more buttons or links, etc., and sends a corresponding signal to bus 202. I/O component 204 may also include an output component, such as a display 211 and a cursor control 213 (such as a keyboard, keypad, mouse, etc.). An optional audio input/output component 205 may also be included to allow a user to use voice for inputting information by converting audio signals. Audio I/O component 205 may allow the user to hear audio. A transceiver or network interface 206 transmits and receives signals between computer system 200 and other devices, such as another user device, a merchant server, or a payment provider server via a network. In one embodiment, the transmission is wireless, although other transmission mediums and methods may also be suitable. A processor 212, which can be a micro-controller, digital signal processor (DSP), or other processing component, processes these various signals, such as for display on computer system 200 or transmission to other devices over a network 260 via a communication link 218. Processor 212 may also control transmission of information, such as cookies or IP addresses, to other devices.

Components of computer system 200 also include a system memory component 214 (e.g., RAM), a static storage component 216 (e.g., ROM), and/or a disk drive 217. Computer system 200 performs specific operations by processor 212 and other components by executing one or more sequences of instructions contained in system memory component 214. Logic may be encoded in a computer readable medium, which may refer to any medium that participates in providing instructions to processor 212 for execution. Such a medium may take many forms, including but not limited to, non-volatile media, volatile media, and transmission media. In various implementations, non-volatile media includes optical or magnetic disks, volatile media includes dynamic memory, such as system memory component 214, and transmission media includes coaxial cables, copper wire, and fiber optics, including wires that comprise bus 202. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computer system 200. In various other embodiments of the present disclosure, a plurality of computer systems 200 coupled by communication link 218 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise.

### Fan Friendly Ticketing

As will be readily appreciated, the foregoing networks, systems, devices, and numerous variations thereof can be used to implement the improved selection and purchase of tickets to ticketed events attended by fans in a more user friendly fashion. Rather than having users resort to known procedures involving separate and often manual steps of searching for tickets and not being sure of what particular seats or nearby fans or other attendees will be like, a more automated and integrated system, user interface and process can be provided. In various embodiments, a ticketed event for a user can be determined either by user selection or by a suggestion from a service provider, such as, for example, eBay Inc. of San Jose, Calif. or Stubhub of San Francisco, Calif.

Service provider suggestions can be based on user information, profile or preferences, for example. Friends, family, coworkers and/or other persons linked to a given user can also provide useful information that can help the system suggest seats that may be more amenable or friendly for a given user. Such suggestions can be made through knowledge of the user and friends, such as likes in music, social and business contacts and friends, types and locations of events, social networking parameters, and the like. Tickets may be suggested by the service provider based on known user preferences, such as general admission seats, loge seats, front row seats, and so forth. Other information can also be used, particularly where the user is not registered or is not logged into the provider system. The other information can be provided by the user (such as via a questionnaire filled out during a set up process), can be provided by people other than the user, can be from websites and databases, and can be information available from any other source, such as via the Internet.

In some embodiments, simply the manner in which a user enters search terms can help the system determine user allegiances or preferences. This can be effective regardless of whether the user has an account, is logged in, or is simply anonymous. For example, a search for “Giants tickets” might indicate that the user is a Giants fan, while a search for “Dodgers tickets” might indicate that the user is a Dodgers fan. Appropriate seating suggestions can then be made based upon what the system already knows about tickets that are already purchased for that game or other ticketed event.

Other factors can also be used to determine what the system might suggest as appropriate seats for a given user. For example, the system might be able to account for whether the user is a casual fan or a hardcore fan, and suggest seats for the user that are appropriate to that particular user. A person who purchase comparatively more tickets, souvenirs, memorabilia and such for a particular team can be consider a hardcore fan. Conversely, a person who purchase comparatively fewer tickets, souvenirs, memorabilia and such for a particular team can be consider a casual fan.

A user's purchasing history and purchasing histories of others can be considered when determining seating arrangements. In this manner, a fan that would rather go to the game to drink and socialize can be seated near similar or other like-minded fans, while other fans that are seriously into the game, players and the like can be seated near other similar fans. Various other details and features may also be included, as will be appreciated.

Other data might also be used to determine whether a given user is a local or an out of town fan or attendee. Such data might be the IP address of the user, GPS, or other anonymous yet useful input. Other factors that the system might consider in making seat or ticket suggestions can relate to the range of ticket prices that the user is or has been perusing, demographic information, and past purchases or searches, to the extent that such information is available.

User tagged favorites can include information with respect to, for example, artist, venue, team, location, show, and the like. Social networking information can include likes, interests, past events, wants, owns and so forth, such as may be found on social networking websites such as Facebook, YouTube, Twitter, LinkedIn, Yelp, MeetMe, MyYearbook, Google+, MySpace, Pinterest, and the like, among other possible websites. External information can include song or artist lists on a separate user device or profile, as well as data from media websites or applications, such as Pandora, Spotify, iTunes, and the like.

In various embodiments, ticketed events can be social or recreational events, such as concerts and sporting events. Alternatively such events can be business related events, such as business meetings, conferences, retreats, and the like. The user-defined criteria for such recreational events can include the names of specific friends who the user wants to know are attending. Other user-defined criteria for such recreational events can include attributes of people such as their sex, age, or any other attributes for which information can be obtained. The user-defined criteria for business related events can include the names of co-workers, superiors (supervisors, managers, officers of a company, members of a board of directors, stockholders, and the like), employees, guests (such as guest speakers) and the like who the user wants to know are attending.

The user-defined criteria for any events can include shared social attributes. Such social attributes can include likes, dislikes, ages, sexes, and the like. Different social attributes can be used with different types of events. For example, the user may want to attend baseball games only with other beer drinkers (or conversely, the user may want to attend baseball games only with other non-drinkers). In this manner, the user can apply social filtering to the event. User-specified types of events can be filtered out or omitted. For example, if the user does not want to attend basketball games, then basketball games can be omitted from the set of possible suggested events. User-specified types of events can be highlighted. For example, if the user is particularly interested in attending hockey games, then hockey games can be preferred for suggestion. The events can be filtered on any desired criteria. For example, the events can be filtered on other criteria such as venue size, type of food served, type of beverages offered (such as alcoholic vs. only non-alcoholic), smoking vs. non-smoking, type of seating (plush vs. hard), and the like.

Available tickets, sections and/or price ranges can be obtained or provided to the user by way of structured data from the service provider and/or other sources. Such data can be presented to the user in a manner so as to readily facilitate the selection of preferred section and/or pricing options that may be suitable for the user. Results can be organized or constrained by the section/prices that the user prefers or has otherwise indicated to be of interest. Once the user has found the right tickets, he or she can go to the appropriate service provider display or page and select one or more payment or additional action options.

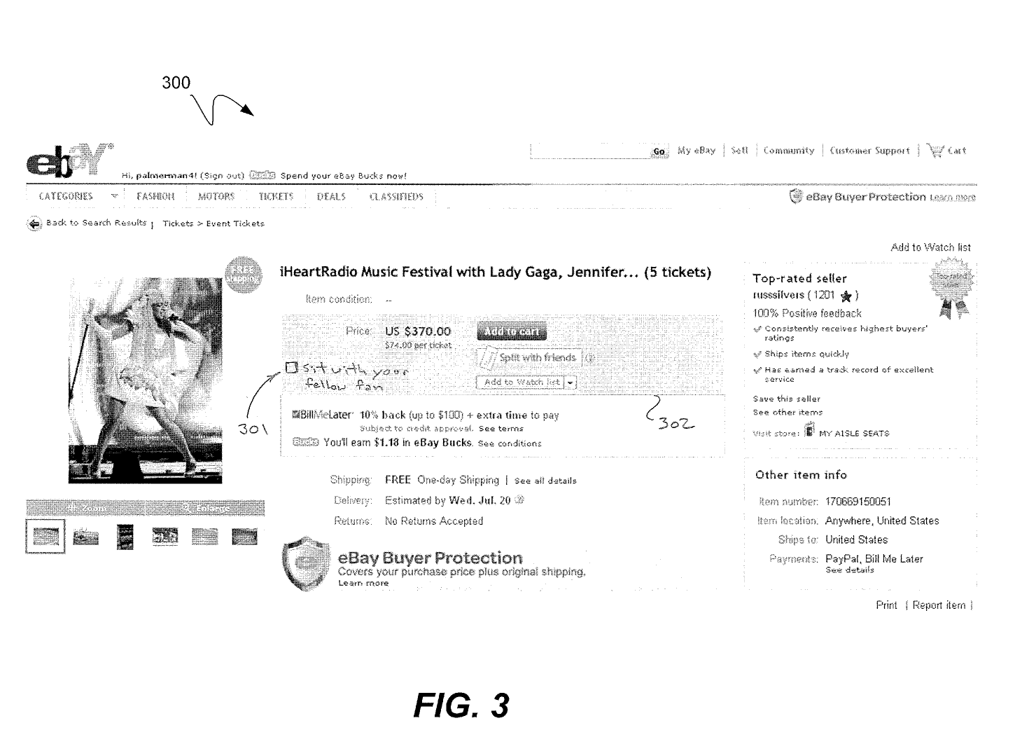

FIG. 3 illustrates a screenshot of an exemplary service provider interest page offering multiple tickets to a ticketed event of interest according to one embodiment of the present invention. Interest page screenshot 300 represents one example of what might be depicted to a user interest in tickets to an event, and can include a variety of items, such as a title, picture(s), seller, price, and description of a ticketed event. Of course, other types of ticketed events can also be presented, such as, for example, sporting events between different teams or individuals.

The user can elect for the system to attempt to sit the user, as well as anyone accompanying the user, with fellow fans of the same team. For example, the user can check the box 301 to cause the system to try to find one or more tickets for the user with or near fellow fans. The box 301 can be associated with the Add to Cart process 302, as shown. Alternatively, the box 301 can be associated with any other desired part of the ticket purchase process, such as during ticket selection process or payment process.

The user can be presented with one or more potential seating arrangements in response to checking the box 301. For example, if the system determines that there are three groups of fans seated in different locations, then the user can be provided with information regarding each group and can select which group to sit with.

Use of the box 301 can be defined by the user, such as during a set up process. The user can define the criteria to be used by the system in determining who the user is to sit with. For example, the user can designate that the user is to sit only with fellow fans of the same team and/or that the user is only to sit with other fans that drink alcohol. The user can define priorities during the set up process for box 301. For example, the user can designate that the system is to first try to sit the user with friends, that if no friends are found to then the system is to sit the user with others that the user has sat with before, and that if no friends or others that the user has sat with before are found, then the system is to sit the user with strangers to are fans of the same team as the user.

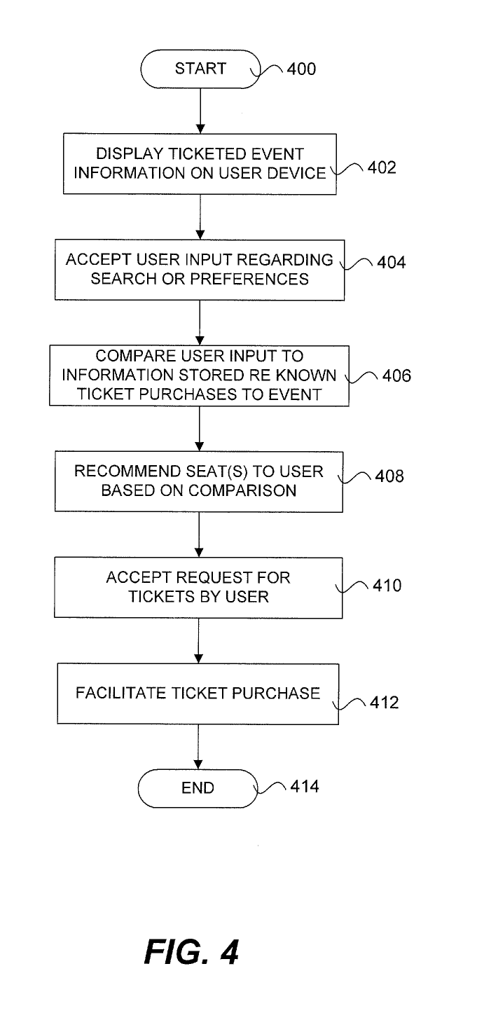

Turning lastly to FIG. 4, a flowchart of an exemplary method of facilitating the purchase of tickets near fellow aligned fans for a ticketed event is provided. In particular, such a method can involve using or operating any of the various computing components, devices, systems and/or networks described above. It will be readily appreciated that not every method step set forth in this flowchart is always necessary, and that further steps not set forth herein may also be included. For example, additional steps can include suggesting ticketed events and accepting payments, among others. Furthermore, the exact order of steps may be altered as desired for various applications.

Beginning with a start step 400, ticketed event information is displayed on a user device at process step 402. A user input regarding a ticket search, preferences, user location, or other useful data can be accepted at process step 404. Using the input information, the system can then check and compare against information such as known ticket purchases for that event at process step 406, whereupon a recommendation for seating or particular tickets can be made to the user at process step 408. The user can then select one or more tickets as suggested at process step 410, whereupon the system can facilitate a ticket purchase on the user device at step 412. The method then ends at an end step 414. Further steps not depicted can include, for example, registering and/or logging onto an actual user account, rejecting some suggestions and asking for others, and/or inputting additional data to help with ticket suggestions, among others.

Various embodiments of the systems and methods discussed above can facilitate various activities related to purchases and attendance at ticketed events. For example, such systems can for facilitate the purchase of tickets that seat the user with fellow fans. Thus, the user can better enjoy the game, such as by cheering for a team with fellow fans of the same team.

Although the foregoing invention has been described in detail by way of illustration and example for purposes of clarity and understanding, it will be recognized that the above described invention may be embodied in numerous other specific variations and embodiments without departing from the spirit or essential characteristics of the invention. Various changes and modifications may be practiced, and it is understood that the invention is not to be limited by the foregoing details, but rather is to be defined by the scope of the claims.

What is claimed is:

1. A computing system, comprising:
one or more memory device or storage components adapted to store user information regarding one or more users of the computing system and event information regarding a plurality of upcoming ticketed events; and
one or more hardware processors in communication with the one or more memory device or storage components and adapted to facilitate displaying information regarding a ticketed event, accepting an input from a user regarding the ticketed event, evaluating the input with respect to known information to determine at least one common factor between the user and one or more attendees who have purchased a ticket for the ticketed event, and making a ticket or seating recommendation based, at least in part, upon the input and evaluation.

2. The computing system of claim 1, wherein the known information is known information regarding previous ticket purchases and is evaluated to determine a team of which the user is a fan and wherein the ticket or seating recommendation is for a seat with other fans of a same team.

3. The computing system of claim 1, wherein the user is determined to be a fan of a team for which the user has performed an online search for a name of the team.

4. The computing system of claim 1, wherein the user is determined to be a fan of a team for which the user has performed an online search for tickets using a name of the team.

5. The computing system of claim 2, wherein the other fans of the same team are determined, at least in part, by online search terms used by the other fans.

6. The computing system of claim 1, wherein the event information includes information regarding the identity of a first event, when and where the first event is happening, and what tickets, sections and pricing are available for the first event.

7. The computing system of claim 1, wherein the one or more hardware processors is further adapted to facilitate providing response information regarding the recommendation to the user.

8. The computing system of claim 1, wherein the ticket or seating recommendation is based, at least in part, on personal information about the user.

9. The computing system of claim 1, wherein the ticket or seating recommendation is suggested based, at least in part, on at least one of a browsing history, a purchase history, social information, location, or interest of the user.

10. The computing system of claim 1, wherein the ticket or seating recommendation is suggested based, at least in part, on entered search terms.

11. A method of facilitating a purchase of tickets for a ticketed event, the method comprising:
displaying, via one or more hardware processors in communication with one or more memory device or storage components, information regarding a ticketed event;
accepting an input, via the one or more hardware processors, from a user regarding the ticketed event;
evaluating the input, via the one or more hardware processors, with respect to known information to determine at least one common factor between the user and one or more attendees who have purchased a ticket for the ticketed event; and
making, via one or more hardware processors, a ticket or seating recommendation based, at least in part, upon the input and evaluation.

12. The method of claim 11, wherein the known information is known information regarding previous ticket purchases and further comprising evaluating the known information to determine a team of which the user is a fan and wherein the ticket or seating recommendation is for a seat with other fans of a same team.

13. The method of claim 11, further comprising determining the user to be a fan of a team for which the user has performed an online search for a name of the team.

14. The method of claim 11, further comprising determining the user to be a fan of a team for which the user has performed an online search for tickets using a name of the team.

15. The method of claim 12, determining, at least in part, that the other fans are fans of the same team via a use of online search terms used by the other fans.

16. The method of claim 11, wherein the event information includes information regarding the identity of a first event, when and where the first event is happening, and what tickets, sections and pricing are available for the first event.

17. The method of claim 11, further comprising providing, via the one or more hardware processors, response information regarding the recommendation to the user.

18. The method of claim 11, wherein the ticket or seating recommendation is based, at least in part, on personal information about the user.

19. The method of claim 11, wherein the ticket or seating recommendation is suggested based, at least in part, on at least one of a browsing history, a purchase history, social information, location, or interest of the user.

20. The method of claim 11, wherein the ticket or seating recommendation is suggested based, at least in part, on entered search terms.

21. A non-transitory medium having a plurality of machine-readable instructions which, when executed by one or more hardware processors of a server controlled by a service provider, are adapted to cause the server to perform a method comprising:
displaying information regarding a ticketed event;
accepting an input from a user regarding the ticketed event;
evaluating the input with respect to known information to determine at least one common factor between the user and one or more attendees who have purchased a ticket for the ticketed event; and
making a ticket or seating recommendation based, at least in part, upon the input and evaluation.
